(19) United States
(12) Patent Application Publication
(10) Pub. No.: US 2024/0109038 A1
(43) Pub. Date: Apr. 4, 2024

(54) Water Purification System And Method

(71) Applicant: Merck Patent GmbH, Darmstadt (DE)

(72) Inventors: Pascal Roitel, Strasbourg (FR); Christophe Paragot, Saclay (FR); Emmanuel Feuillas, Brezolles (FR); Stephane Dupont, Elancourt (FR)

(21) Appl. No.: 18/541,022

(22) Filed: Dec. 15, 2023

Related U.S. Application Data
(62) Division of application No. 15/525,710, filed on May 10, 2017, now abandoned.

(30) Foreign Application Priority Data
Nov. 11, 2014 (EP) 14290342.6

(51) Int. Cl. B01D 61/12; B01D 61/02; B01D 61/46; B01D 61/54; B01D 61/58; C02F 1/00; C02F 1/44; C02F 1/469; C02F 9/20

(52) U.S. Cl. CPC B01D 61/12; B01D 61/025; B01D 61/46; B01D 61/54; B01D 61/58; C02F 1/008; C02F 1/441; C02F 1/4695; C02F 9/20; B01D 61/48; B01D 2311/243; B01D 2311/25; C02F 2201/005; C02F 2209/03; C02F 2209/05; C02F 2209/40

(57) ABSTRACT

A method of purifying tap water to produce deionized type 2 pure water on a laboratory scale with a volume of up to 300 l/h using a water purification system, the method including detecting the permeate flow rate produced by a reverse-osmosis device downstream of a permeate outlet; detecting the flow rate of retentate flow that is removed from the system downstream of a first flow rate regulator; and remote controlling the first and a second flow rate regulators based on the detection results from first and second flow meters such that a predetermined target recovery rate and a predetermined target permeate flow rate are controlled.

This application is a divisional of U.S. patent application Ser. No. 15/525,710 filed May 10, 2017, which is a 371 of PCT/EP2015/002137 filed Oct. 28, 2015, the disclosures of which are incorporated herein by reference in their entireties.

The present invention relates to a water purification system and to a method of purifying water, both on a laboratory scale involving production of up to 300 l/h of deionized type 2 pure water from tap water. The system and method are further particularly directed to a situation where the feed tap water is treated by a combination of a reverse-osmosis stage (RO) and an electro-deionization stage (EDI).

### TECHNICAL BACKGROUND

Deionized water is also referred to as type 2 pure water. The typical physical properties of type 2 pure water are a resistivity over 5 Ma cm and a total organic carbon (TOC) amount (carbon bound in an organic compound) below 30 ppb. Such pure water is widely used in laboratories in the academic, research and clinical fields and typical applications for the deionized water in these fields are buffer preparation, pH solution preparation, feed to clinical analyzers or weatherometers (laboratory devices that use high-powered light sources and water to simulate long-term outside exposure) or washing machines or stainless steel autoclaves, and the preparation of reagents for chemical analysis or synthesis. The daily consumption in a laboratory of type 2 pure water is up to 3000 liters. Type 2 pure water is produced out of tap water. The most popular process to get deionized water has been to pass the water through anionic and cationic exchange resin. This process is still widely in use today. Ion exchange resin gets exhausted after some volume of water has been treated, therefore periodic chemical regeneration of the ion exchange media is required. This chemical regeneration of the media is one of the major drawbacks of this purification process.

Electro-deionization (EDI), also identified as continuous electro-deionization, relies on electric current to carry the ionic species from a dilute compartment to a concentrate compartment. It follows that two streams come out of the EDI module: the product—type 2 pure water—and the concentrate that goes to the drain. EDI technology is not appropriate to remove the bulk of contaminants contained in tap water. Therefore a first step of purification is required. Reverse Osmosis (RO) is the first step of purification that removes 97 to 99% of the ions contained in the tap water. The major benefit of the combination RO/EDI is that no periodic chemical regeneration is required over time as no media get exhausted. On the other side, both RO and EDI purification stages remove ions at the expense of a fraction of the feed water being dumped to the drain. Typically, recovery for the RO stage is between 30% and 70% and for the EDI stage 75%. It results that the recovery rate for the RO/EDI combination ranges from 25% to 50%, in other words the quantity of feed water required to produce 100 liters of type 2 pure water ranges from 177 liters to 400 liters. Considering a typical installation that is operated to produce 1000 liters of type 2 pure water daily, 300 days per year, the quantity of feed water required per year will range from 620 cubic meters to 1200 cubic meters which is a considerable and increasing cost factor.

The RO process requires water free from chlorine compounds and particulates. Assuming the operating costs for the dechlorination step being the same order of magnitude than the operating costs for the feed water, the total operating costs for the pretreated feed water will be considerable. The EDI module is an electrochemical device that requires its feed water stream characteristics to be within specific limits in order to work properly. The EDI module has to be run between two operating limits:
1) insufficient deionization current: the product water does not meet the expected quality expressed as electrical resistivity, meaning the ion concentration of the purified water is too high.
2) too much deionization current: the electrical impedance of the EDI module seen by the power supply increases too much over time, meaning the module is subject to scaling, the end result being that the lifespan of the module is drastically shortened.

The deionization current is the key parameter to be set properly to prevent any of these two failures to occur. The tendency for scaling also depends on the calcium and magnesium ion (Ca²⁺ and Mg²⁺) content of the EDI feed water: the higher the concentration of calcium, the higher the risk of scaling. At this point, the control strategy of the RO/EDI combination consists to insure that the EDI feed water ionic load and the Ca²⁺ and Mg²⁺ concentration do not exceed specific limits. The RO stage is expected to provide the EDI feed water whose characteristics are within the EDI requirements.

Reverse Osmosis (RO) is a purification process known as a tangential purification process. The RO pump pushes the feed stream against the RO membrane where the feed stream is divided into the concentrate and the permeate stream. The efficiency of the RO process is referred to as “rejection” and a typical rejection rate is 97 to 99%, meaning that 97 to 99% of the dissolved salts are removed from RO feed water. During the purification process, contaminants are concentrated along the membrane, requiring a minimal tangential speed to prevent the contaminants from accumulating on the RO surface membrane. A typical membrane recovery which is characterized as the ratio between the feed stream and the permeate stream is 15% so that the concentrate flow effectively represents 85% of the RO feed stream. In an attempt to save water, part of the concentrate stream is recirculated, the other part is rejected to the drain.

The recirculated part is mixed to the incoming tap water in a proportion calculated so as to have a RO stage recovery within 30 and 70% as mentioned before.

Several considerations should be taken into consideration to compute the optimal RO stage recovery:
1. the failure mode of the RO membrane
2. the requirements of the EDI module,
   2.1. the maximum permeate ionic load
   2.2. the maximum permeate Ca concentration.

1. Failure Mode of the RO Membrane:

SDI (Silt Density Index), TDS (Total Dissolved Solids), LSI (Langelier Saturation Index) and chlorine concentration are the key parameters to be considered to protect the RO membrane. Of these parameters only the LSI is discussed in more detail. Increasing the RO stage recovery will concentrate all minerals content in the RO feed water. At some point, calcium will precipitate in the concentrate stream of the RO process. This is to be avoided as it causes the RO membrane to clog. The Langelier model quantifies the risk of scaling. Some properties of the feed water have to be known to compute the LSI: alkalinity, pH, CO₂ concentration and temperature. Using that model will allow to compute the maximum allowable recovery of the RO stage to prevent scaling.

2. Requirements of the EDI Module

2.1. Maximum RO Permeate Ionic Load:

The ionic load is best represented by permeate conductivity. The permeate conductivity can be monitored using a conductivity cell and the appropriate electronic circuitry. Permeate conductivity depends on the RO membrane rejection and RO feed water conductivity. The higher the RO membrane rejection, the lower the salt passage and the lower the permeate conductivity. Maximum RO stage recovery can therefore be computed so as to never exceed the maximum permeate ionic load.

2.2. Maximum Permeate Ca²⁺/Mg²⁺ Ion Concentration:

Ca/Mg is well rejected by the RO membrane, usually at around 99,5%. MerckMillipore® EDI modules went through numerous improvements over the years to improve scaling resistance. The typical resistance for a MerckMillipore® EDI module is 3 ppm as CaCO₃. With a 99,5% rejection, this makes the maximal Ca concentration of the RO feed at 600 ppm. The maximum RO recovery shall take this third constraint also into consideration.

A second requirement of the EDI module is the feed flow rate. An EDI module is an electrochemistry device that depends entirely on the RO stage to be provided with a constant flow rate. Electro-deionization is a process that requires time to reach steady state which is a desirable condition to perform properly. Increasing the flow rate would increase the ionic load, decreasing the flow rate would decrease the ionic load. Therefore the EDI module would show the failure associated with too high ionic load or with too low ionic load (poor water quality and risk of scaling). RO pressure, RO membrane permeability, water temperature and osmotic pressure are the four key parameters to control the RO flow rate.

Thus, the key parameters to be controlled in a RO/EDI combination depending on the tap water characteristics are permeate flow rate, RO recovery and electro-deionization current. Considering further that the daily needs of type 2 purified water in laboratory scale applications to which the present invention pertains are 300 to 3000 liters, the RO/EDI combination requires a pump that can provide a capacity of 700 liters per hour (l/h) at an operating pressure of up to 15 bar (because, depending of the tap water characteristics—mainly temperature and conductivity—the RO pressure may vary from 3.5 bars up to 15 bar). A suitable pump technology for 700 l/h and a pressure of 15 bar (15 kPa) is a rotary vane pump as an example of a positive displacement pump.

The tap water analysis is performed upon system installation and an optimum RO stage recovery is normally computed to prevent scaling while minimizing the amount of water sent to the drain. Then, the RO pressure and RO recovery are set on an installation site according to the above mentioned philosophy. The major drawback of this process is that it requires frequent manual adjustments. Since the RO flow rate is very dependent on feed water temperature, the feed water temperature changes over the seasons of the year will cause variations of the permeate flow rate will reduce the water quality and the life time of the purification chain. To avoid frequent adjustments the RO stage recovery was normally set and maintained at the low value of 33% to accommodate the changes of tap water quality without compromising the pure water quality.

EP 1457460 A2 describes a water purification system and method that allows controlling the RO flow rate whatever the feed water temperature. The system has a reverse-osmosis device for producing a permeate flow and a concentrate flow from a feed water flow, an electro-deionization means having its inlet in fluid communication with the permeate outlet of the reverse-osmosis device, and a purified water outlet. A pump is connected to the feed water flow path for elevating the pressure of the feed medium and supplying the feed water under pressure to the feed inlet of the reverse-osmosis device. A retentate flow path in fluid communication with the retentate outlet of the reverse-osmosis device is provided for removing retentate from the system. The flow rate can be controlled by a flow rate regulator with a variable restriction. A further retentate flow path in fluid communication with the retentate outlet of the reverse-osmosis device is provided for recirculating retentate to the feed flow path at an upstream position of the pump and the recirculation flow path includes an adjustable pressure regulator. The technology includes supplying an EDI module with a constant flow rate by placing a flow rate regulator on the permeate flow downstream of the RO stage. The flow regulator is an elastic eyelet forming a variable orifice—the higher the upward pressure, the smaller the orifice and the higher the pressure drop across the eyelet. The elastic eyelet solution has some limitations because it works only in the range of 1 to 10 bar. The pump runs at its maximum load (15 bar) which corresponds to an assumed worst case of low temperature feed water, e.g. the RO permeability. Further, as some of the maximal hydraulic power of the pump is lost in the flow rate control mechanism (about 7%), this known system has a relative high power consumption and could cause premature wear of the pump. Further, the accuracy is limited (+/−15%). Therefore, an average RO stage recovery of the system in operation is close to 50%.

EP 1466656 A2 discloses a water purification system in which the electro-deionization module comprises three stages in series wherein the deionization current can be controlled independently in each stage. It is known that the ionized species can be differentiated into three categories: high dissociated species, carbon dioxide (CO₂) and low ionized species such as silica and boron. It is desirable to prevent scaling to remove in a sequential manner first the high dissociated species, secondly the carbon dioxide and thirdly the low ionized species. Three different deionization currents are computed and applied to each deionization stage. This system depends on a specific technical solution to regulate the operating parameters: an eyelet forming a variable orifice to provide a constant flow rate, a combination of backpressure and needle valve to provide a constant RO recovery, and a three-ways regulated direct current to provide constant current. The control philosophy of the system of EP 1466656 A2 is as follows: upon installation on a specific geographic location, a tap water analysis is performed (feed conductivity, hardness, carbon dioxide concentration, temperature), RO recovery and the DC deionization currents are computed so as to minimize the water to the drain, and the RO recovery and deionization currents are manually set on the system. As the properties of the feed water (contaminants concentration, temperature) as well as the salt rejection of the RO membrane change over time, periodic feed water analysis and manual operating parameter adjustments have to be done. In the real world, to prevent periodic intervention on the installation site, a service engineer will apply in advance some safety factors with the settings of the expected operating parameters. This approach is detrimental to the water consumption and the long term integrity of the EDI module.

It is therefore an object of the present invention to provide a water purification system and a method of purifying water that are based on a combination of a reverse-osmosis stage (RO) and an electro-deionization stage (EDI), that are both designed for laboratory scale involving production of up to 300 l/h of deionized type 2 pure water from tap water, and that are improved with respect to the water consumption in that the amount of water discharged to the drain is reduced, that can maintain the integrity of the membrane of the RO device and the integrity of the EDI device over a long time, and that require less manual service intervention.

Another aspect of the present invention is to provide a system and method of the above mentioned type which can monitor, preferably in real time, too, the key feed (tap) water contaminants without resorting to expensive tools and dedicated sensors.

To solve the problem the invention provides a laboratory scale water purification system for producing up to 300 l/h deionized type 2 pure water from tap water as defined by claim 1 or 2 and a method according to claim 14 or 15 of purifying tap water to produce deionized type 2 pure water on a laboratory scale with a volume of up to 300 l/h using a water purification system.

Preferred embodiments of the system and method are defined in the dependent claims and will become apparent from the following description.

According to a first aspect the invention provides a laboratory scale water purification system for producing up to 300 l/h deionized type 2 pure water from tap water, said system comprising:
a feed medium flow path (C) including a pump for elevating the pressure of the feed medium and supplying the feed medium under pressure to a feed inlet of a reverse-osmosis device, wherein the reverse-osmosis device is adapted to produce a permeate flow and a concentrate flow from the feed medium and has a permeate outlet and a retentate outlet;
an electro-deionization device having an inlet in fluid communication with the permeate outlet of the reverse-osmosis device, and a purified water outlet;
a first retentate flow path (A) in fluid communication with the retentate outlet of the reverse-osmosis device, for removing retentate from the system, said first retentate flow path (A) including a first flow rate regulator adapted to be remote controlled;
a second retentate flow path (B) in fluid communication with the retentate outlet of the reverse-osmosis device for recirculating retentate to the feed medium flow path at an upstream position of the pump, said second retentate flow path (B) including a second flow rate regulator adapted to be remote controlled;
a first flow meter downstream of the permeate outlet of the reverse-osmosis device for detecting the permeate flow rate produced by the reverse-osmosis device;
a second flow meter provided in the first retentate flow path (A) downstream of the first flow rate regulator for detecting the flow rate of the retentate flow that is removed from the system; and
an automatic controller for remote controlling the first and second flow rate regulators based on the detection results from the first and second flow meters such that a predetermined target recovery rate and a predetermined target permeate flow rate are controlled for the reverse-osmosis device.

According to a second aspect the invention provides a laboratory scale water purification system for producing up to 300 l/h deionized type 2 pure water from tap water, said system comprising:
a feed medium flow path (C,E) including a pump for elevating the pressure of the feed medium and supplying the feed medium under pressure to a feed inlet of a reverse-osmosis device, wherein the reverse-osmosis device is adapted to produce a permeate flow and a concentrate flow from the feed medium and has a permeate outlet and a retentate outlet;
an electro-deionization device having an inlet in fluid communication with the permeate outlet of the reverse-osmosis device (2), and a purified water outlet;
a first retentate flow path (A) in fluid communication with the retentate outlet of the reverse-osmosis device, for removing retentate from the system, said first retentate flow path (A) including a first flow rate regulator adapted to be remote controlled;
a second retentate flow path (B) in fluid communication with the retentate outlet of the reverse-osmosis device for recirculating retentate to the feed medium flow path at an upstream position of the pump, said second retentate flow path (B) including a second flow rate regulator adapted to be remote controlled;
a first flow meter downstream of the permeate outlet of the reverse-osmosis device for detecting the permeate flow rate produced by the reverse-osmosis device;
a first conductivity cell provided in the first retentate flow path (A) for detecting the conductivity (ion concentration) of the retentate flow;
a second conductivity cell provided in the feed medium flow path (E) for detecting the conductivity (ion concentration) of the feed medium flow; and
an automatic controller for controlling the first and second flow rate regulators based on the detection results from the first flow meter and the first and second conductivity cells such that a predetermined target recovery rate and a predetermined target permeate flow rate are controlled for the reverse-osmosis device.

According to a preferred embodiment of the invention, in order to control the predetermined target permeate flow rate, the controller is adapted to simultaneously close the first and second flow rate regulators to increase the permeate flow rate and/or to simultaneously open the first and second flow rate regulators to decrease the permeate flow rate.

According to another preferred embodiment of the invention, in order to control the predetermined target recovery rate and to keep the permeate flow rate substantially constant, the controller is adapted to close the second flow rate regulator and open the first flow rate regulator to decrease the recovery rate of the reverse-osmosis device, and/or to open the second flow rate regulator and close the first flow rate regulator to increase the recovery rate for the reverse-osmosis device.

According to another preferred embodiment of the invention, in order to control a predetermined target minimum pressure, the controller is adapted to simultaneously close the first and second flow rate regulators to increase the pressure, and/or, in order to control a predetermined target maximum pressure, the controller is adapted to simultaneously open the first and second flow rate regulators to decrease the pressure, and/or, in order to control a predetermined target pressure variation, the controller is adapted to simultaneously decrease the closing or opening speeds of the first and second flow rate regulators to decrease the recovery pressure variation.

According to another preferred embodiment, especially of the first aspect of the invention, the controller is adapted to control the predetermined target recovery rate in a closed loop (feedback control), and the controller is adapted to determine the current recovery rate of the reverse-osmosis device based on the detection result of the first and second flow meters according to the following relation:
(recovery rate of the reverse-osmosis device)=(permeate flow rate at the outlet of the reverse-osmosis device)/(permeate flow rate at the outlet of the reverse-osmosis device+flow rate of the retentate flow that is removed from the system).

According to another preferred embodiment, especially of the second aspect of the invention, the controller is adapted to control the predetermined target recovery rate in a closed loop (feedback control).

According to another preferred embodiment of the invention a pressure sensor is provided for detecting the pressure of the retentate flow in the first (A) and/or the second retentate flow path (B), and the controller is adapted to determine a difference between a predetermined retentate pressure value and the value detected by the pressure sensor and to issue an indication/alarm if the difference exceeds a threshold (meaning that the membrane in the RO device is to be cleaned/replaced).

According to another preferred embodiment of the invention a/the pressure sensor is provided for detecting the pressure of the retentate flow in the first (A) and/or the second retentate flow path (B) and the controller is adapted to perform a pump testing routine including: closing the second flow rate regulator; increasing the retentate pressure by closing the first flow rate regulator; monitoring the detected retentate pressure from the pressure sensor; and comparing the flow rate of the retentate flow detected by the second flow meter with a flow rate threshold value predetermined for a specific retentate pressure value corresponding to that detected by the pressure sensor, and issuing an indication/warning if the flow rate detected by the second flow meter is lower than said threshold value.

According to another preferred embodiment of the invention the controller is arranged to allow (a preferably manual) setting of a predetermined initial target recovery rate of the reverse-osmosis device, and optionally of an initial deionization current of the electro-deionization device, which are respectively predetermined based on a feed medium analysis of one or more of the parameters feed conductivity, hardness, carbon dioxide concentration, and temperature, and so as to minimize the amount of the feed medium removed from the system through the first retentate flow path (A), and wherein the electro-deionization device preferably comprises at least three stages in series for which the deionization current can be independently controlled by the controller.

According to another preferred embodiment of the invention, the laboratory scale water purification system further comprises a third conductivity cell provided in the feed medium flow path (C) for detecting the conductivity (ion concentration) of the feed medium flow; a fourth conductivity cell provided in a permeate flow path (D) downstream of the reverse-osmosis device for detecting the conductivity (ion concentration) of the permeate flow; and wherein the controller is adapted to determine the actual rejection of the reverse-osmosis device based on the ratio of the detection results from the third and fourth conductivity cells, to adjust the target recovery rate of the reverse-osmosis device depending on the determined actual rejection of the reverse-osmosis device to a value at which the ionic load (Ca²⁺ and Mg²⁺ load) of the permeate flow is at or below a predetermined admissible value for the electro-deionization device, preferably of the first stage thereof, and, if necessary, to adjust the deionization current of the electro-deionization device, preferably of the first stage thereof, accordingly.

According to another preferred embodiment of the invention, the laboratory scale water purification system further comprises a fifth conductivity cell provided downstream of the purified water outlet of the electro-deionization device for detecting the conductivity (ion concentration) of the purified water; and wherein the controller is adapted to determine the CO₂ content of the purified water based on the detection results from the fifth conductivity cell, and to adjust the deionization current of the electro-deionization device, preferably of the second and, if provided, of the third stage thereof accordingly.

According to another preferred embodiment of the invention the controller is adapted to perform the control of the target permeate flow rate and/or of the target recovery rate and/or of the target concentration factor and/or of the deionization current of the electro-deionization device, preferably of individual stages thereof if provided, in a closed loop (by feedback control), preferably in real time.

According to another preferred embodiment of the invention the first and/or second flow rate regulator is/are a remote controllable motorized needle valve.

According to a third aspect the invention provides a method of purifying tap water to produce deionized type 2 pure water on a laboratory scale with a volume of up to 300 l/h using a water purification system which comprises:
a feed medium flow path including a pump for elevating the pressure of the feed medium and supplying the feed medium under pressure to a feed inlet of a reverse-osmosis device, wherein the reverse-osmosis device is adapted to produce a permeate flow and a concentrate flow from the feed medium and has a permeate outlet and a retentate outlet;
an electro-deionization device having an inlet in fluid communication with the permeate outlet of the reverse-osmosis device, and a purified water outlet;
a first retentate flow path (A) in fluid communication with the retentate outlet of the reverse-osmosis device, for removing retentate from the system, said first retentate flow path (A) including a first flow rate regulator adapted to be remote controlled; and
a second retentate flow path (B) in fluid communication with the retentate outlet of the reverse-osmosis device for recirculating retentate to the feed medium flow path at an upstream position of the pump, said second retentate flow path (B) including a second flow rate regulator adapted to be remote controlled;
wherein the method comprises:
detecting the permeate flow rate produced by the reverse-osmosis device downstream of the permeate outlet;
detecting the flow rate of the retentate flow that is removed from the system downstream of the first flow rate regulator; and
remote controlling the first and second flow rate regulators based on the detection results from the first and second flow meters such that a predetermined target recovery rate and a predetermined target permeate flow rate are controlled for the reverse-osmosis device.

According to a fourth aspect the invention provides a method of purifying tap water to produce deionized type 2 pure water on a laboratory scale with a volume of up to 300 l/h using a water purification system which comprises:
a feed medium flow path including a pump for elevating the pressure of the feed medium and supplying the feed medium under pressure to a feed inlet of a reverse-osmosis device, wherein the reverse-osmosis device is adapted to produce a permeate flow and a concentrate flow from the feed medium and has a permeate outlet and a retentate outlet;
an electro-deionization device having an inlet in fluid communication with the permeate outlet of the reverse-osmosis device, and a purified water outlet;
a first retentate flow path (A) in fluid communication with the retentate outlet of the reverse-osmosis device, for removing retentate from the system, said first retentate flow path (A) including a first flow rate regulator adapted to be remote controlled; and
a second retentate flow path (B) in fluid communication with the retentate outlet of the reverse-osmosis device for recirculating retentate to the feed medium flow path at an upstream position of the pump, said second retentate flow path (B) including a second flow rate regulator adapted to be remote controlled;
wherein the method comprises:
detecting the permeate flow rate produced by the reverse-osmosis device downstream of the permeate outlet;
detecting the conductivity (ion concentration) of the retentate flow;
detecting the conductivity (ion concentration) of the feed medium flow; and
controlling the first and second flow rate regulators based on the permeate flow rate produced by the reverse-osmosis device and the conductivity (ion concentration) of the retentate flow and the conductivity (ion concentration) of the feed medium flow such that a predetermined target recovery rate and a predetermined target permeate flow rate are controlled for the reverse-osmosis device.

According to a preferred embodiment of the method according to the third and fourth aspect of the invention, in order to control the predetermined target permeate flow rate, the first and second flow rate regulators are simultaneously closed to increase the permeate flow rate and/or the first and second flow rate regulators are simultaneously opened to decrease the permeate flow rate.

According to a further preferred embodiment of the method according to the third and fourth aspect of the invention, in order to control the predetermined target recovery rate and to keep the permeate flow rate substantially constant, the second flow rate regulator is closed and the first flow rate regulator is opened to decrease the recovery rate of the reverse-osmosis device, and/or to the second flow rate regulator is opened and the first flow rate regulator is closed to increase the recovery rate for the reverse-osmosis device.

According to a still further preferred embodiment of the method according to the third and fourth aspect of the invention, in order to control a predetermined target minimum recovery pressure, the first and second flow rate regulators are simultaneously closed to increase the recovery pressure, and/or, in order to control a predetermined target maximum recovery pressure, the first and second flow rate regulators are simultaneously opened to decrease the recovery pressure, and/or, in order to control a predetermined target recovery pressure variation, the closing or opening speeds of the first and second flow rate regulators are simultaneously decreased to decrease the recovery pressure variation.

According to a further preferred embodiment of the method according to the third aspect of the invention, the predetermined target recovery rate is controlled in a closed loop (by feedback control), and the current recovery rate of the reverse-osmosis device is determined based on the permeate flow rate at the outlet of the reverse-osmosis device and the flow rate of the retentate flow that is removed from the system according to the following relation:
(recovery rate of the reverse-osmosis device)=(permeate flow rate at the outlet of the reverse-osmosis device)/(permeate flow rate at the outlet of the reverse-osmosis device+flow rate of the retentate flow that is removed from the system).

According to a further preferred embodiment of the method according to the fourth aspect of the invention the predetermined target recovery rate is controlled in a closed loop (by feedback control).

According to a further preferred embodiment of the method according to the third and fourth aspect of the invention the method comprises detecting the pressure of the retentate flow in the first (A) and/or the second retentate flow path (B), and determining a difference between a predetermined retentate pressure value and the pressure of the retentate flow and issueing an indication/alarm if the difference exceeds a threshold (meaning that the membrane in the RO device is to be cleaned/replaced).

According to a further preferred embodiment of the method according to the third and fourth aspect of the invention the method comprises detecting the pressure of the retentate flow in the first (A) and/or the second retentate flow path (B) and performing a pump testing routine including: closing the second flow rate regulator; increasing the retentate pressure by closing the first flow rate regulator; monitoring the detected retentate pressure; and comparing the flow rate of the retentate flow with a flow rate threshold value predetermined for a specific retentate pressure value corresponding to the detected retentate pressure value, and issueing an indication/warning if the detected flow rate is lower than said threshold value.

According to a further preferred embodiment of the method according to the third and fourth aspect of the invention the method comprises, preferably manually, setting of a predetermined initial target recovery rate of the reverse-osmosis device, and optionally of an initial deionization current of the electro-deionization device, which are respectively predetermined based on a feed medium analysis of one or more of the parameters feed conductivity, hardness, dissolved carbon dioxide concentration, and temperature, and so as to minimize the amount of the feed medium removed from the system through the first retentate flow path (A), and wherein the electro-deionization device preferably comprises at least three stages in series for which the deionization current can be independently controlled.

According to a further preferred embodiment of the method mentioned before, the method comprises detecting the conductivity (ion concentration) of the feed medium flow; detecting the conductivity (ion concentration) of the permeate flow; and determining the actual rejection of the reverse-osmosis device based on the ratio of the detected conductivity (ion concentration) of the feed medium flow and permeate flow, adjusting the target recovery rate of the reverse-osmosis device depending on the determined actual rejection of the reverse-osmosis device to a value at which the ionic load (Ca²⁺ and Mg²⁺ load) of the permeate flow is at or below a predetermined admissible value for the electro-deionization device, preferably of the first stage thereof, and, if necessary, adjusting the deionization current of the electro-deionization device, preferably of the first stage thereof, accordingly.

According to a further preferred embodiment of the method mentioned before, the method comprises detecting the conductivity (ion concentration) of the purified water; and determining the CO₂ content of the purified water based on the detection result, and adjusting the deionization current of the electro-deionization device, preferably of the second and, if provided, of the third stage thereof accordingly.

According to a further preferred embodiment of the method according to the third and fourth aspect of the invention the control of the target permeate flow rate and/or of the target recovery rate and/or of the target concentration factor and/or of the deionization current of the electro-deionization device, preferably of individual stages thereof if provided, is carried out in a closed loop (by feedback control), preferably in real time.

The system and method of the present invention provide an opportunity to reduce the water consumption in the process of producing the deionized type 2 pure water from tap water while keeping the integrity of the RO device and EDI device in that the feed water quality and preferably the salt rejection of the RO stage are monitored and the critical operating parameters including RO recovery and preferably electro-deionization current of the system/method are automatically controlled and adjusted, preferably in real time. Thus, a change of the feed water conditions has no negative influence on the water consumption and the lifetime of the RO and EDI device and costly service interventions are less frequently required.

In a preferred embodiment the key feed water contaminants (dissolved CO₂, Ca²⁺ and Mg²⁺) can be detected and monitored without resorting to expensive tools and dedicated specialized sensors in that existing or relatively less costly resources (flow rate sensors, conductivity cells) of the water purification system are used.

The following is a non-limiting and exemplary description of preferred embodiments of the flow schematics of the invention explained by reference to the drawing, in which:

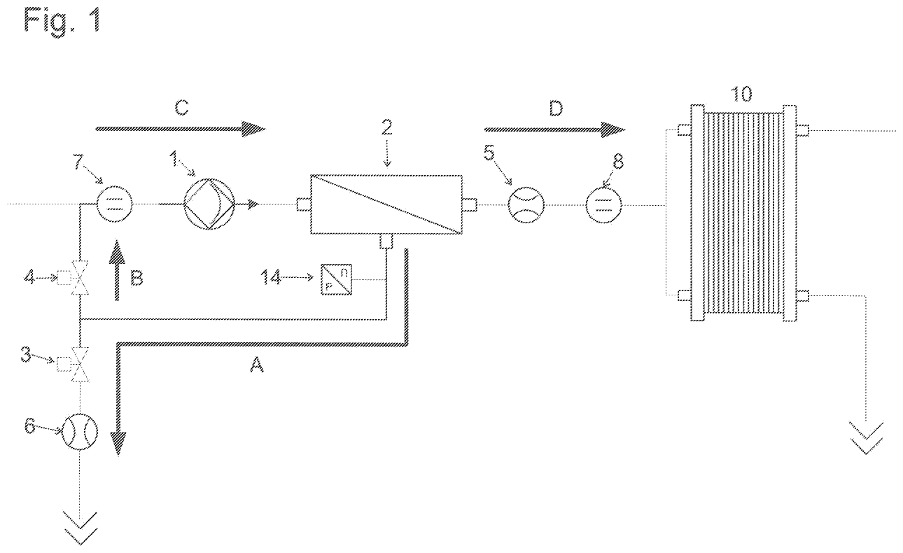

FIG. 1 is a system diagram of a first preferred embodiment of a laboratory scale water purification system,

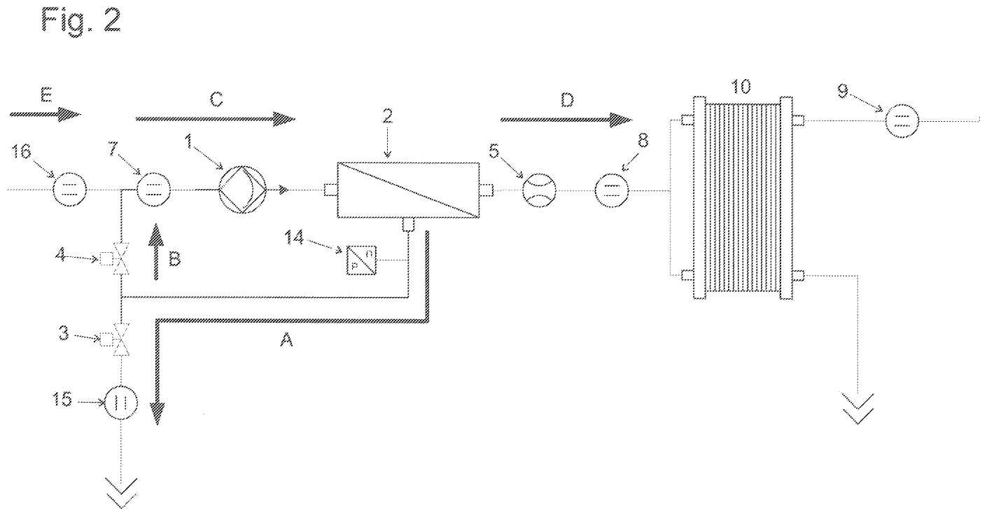

FIG. 2 is a system diagram of a second preferred embodiment of a laboratory scale water purification system, and

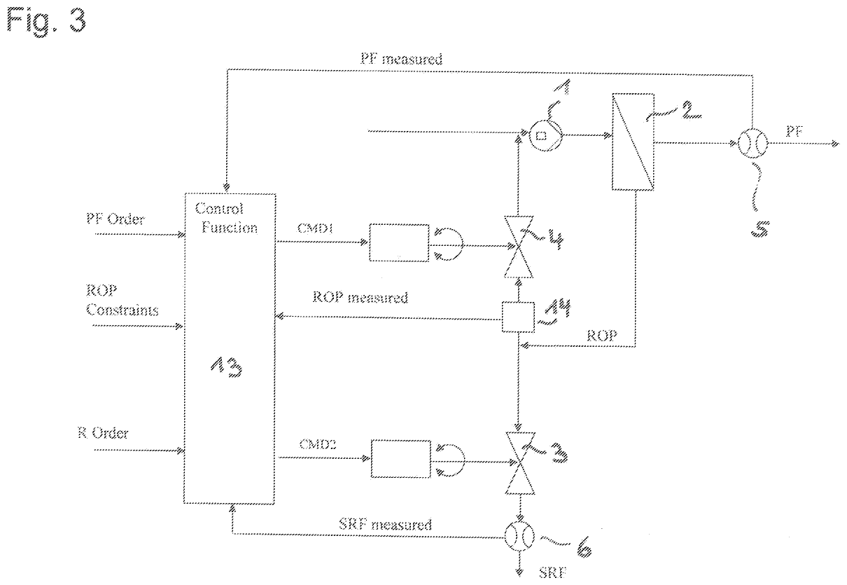

FIG. 3 is a diagram showing the control input and output of the controller of the first embodiment.

The preferred embodiment of the laboratory scale water purification system for producing up to 300 l/h deionized type 2 pure water from tap water of the invention shown in FIG. 1 uses at least two flow meters for controlling the recovery rate and/or permeate flow rate of the reverse-osmosis (in the following “RO”) device in the system. The system has a feed medium flow path C including a positive displacement pump 1 for elevating the pressure of the feed medium (tap water) and supplying the feed medium under pressure to a feed inlet of a RO device 2 which is adapted to produce a permeate flow and a concentrate flow from the feed medium and which has a permeate outlet and a retentate outlet. An electro-deionization (in the following “EDI”) device 10 is provided and has an inlet in fluid communication with the permeate outlet of the reverse-osmosis device 2 and a purified water outlet. The positive displacement pump 1 is arranged to generate a pressurized feed RO stream sized so as to provide the expected RO permeate flow rate as well as the expected concentrate flow rate (the concentrate flow rate is sized so as to tangentially remove the contaminants from the RO membrane using a sweeping effect). The membrane of the RO device 2 is sized so as to generate a specific permeate flow for a specific feed water temperature at a given RO pressure.

A first retentate flow path A is in fluid communication with the retentate outlet of the RO device 2 and serves to remove retentate from the system to a drain. The first retentate flow path A includes a first flow rate regulator 3 adapted to be remote controlled and a second retentate flow path B in fluid communication with the retentate outlet of the RO device 2 for recirculating retentate to the feed medium flow path at an upstream position of the pump 1. The second retentate flow path B includes a second flow rate regulator 4 adapted to be remote controlled. The first flow rate regulator 3 thus has the function of a drain valve 3 which is preferably a motorized needle valve that controls the size of an orifice in order to control the concentrate stream that goes to the drain, and the second flow rate regulator 4 thus has the function of a recirculation valve 4 which is preferably a motorized needle valve that controls the size of an orifice in order the control the recirculated stream.

A first flow meter 5 is provided downstream of the permeate outlet for detecting the permeate flow rate produced by the RO device 2 and a second flow meter 6 is provided in the first retentate flow path A downstream of the first flow rate regulator 3 for detecting the flow rate of the retentate flow that goes to the drain to be removed from the system.

Remote Real Time Control of the RO Permeate Flow Rate and of the RO Recovery

In the first embodiment an automatic controller 13 is provided for remote controlling the first and second flow rate regulators 3,4 based on the detection results from the first and second flow meters 5,6 such that a predetermined target recovery rate and a predetermined target permeate flow rate are controlled for the reverse-osmosis device 2.

The regulation of the permeate flow rate, the RO recovery, a minimal RO pressure, a maximal RO pressure and a RO pressure variation is thus effected in that the pump 1 generates a constant flow upon start up and during running. During system start up the drain valve 3 and the recirculation valve 4 are moved simultaneously with different variable speeds computed by a MIMO (Multiple Inputs Multiple Outputs) control function 13 from an open position to adjust simultaneously the RO pressure and the drain flow rate with a pressure drop variation controlled and the minimal and maximal RO pressures controlled until the flow meter 5 will see the expected permeate flow rate and until the flow meter 6 will see the expected drain flow rate to reach the expected RO recovery.
(RO recovery)=(RO permeate flow rate)/(RO permeate flow rate+flow rate to the drain).

During the system running, if perturbations like, for example, water temperature changes, tap feed pressure variations, feed conductivity drops, occur and change the nominal working points, the drain valve 3 and the recirculation valve 4 are moved simultaneously with different variable speed, computed by the MIMO (Multiple Inputs Multiple Outputs) control function 13, to adjust simultaneously the RO pressure and the drain flow rate with a pressure drop variation controlled and the minimal and maximal RO pressure controlled until the flow meter 5 will see the expected permeate flow rate and until the flow meter 6 will see the expected drain flow rate to reach the expected RO recovery.

The MIMO (Multiple Inputs Multiple Outputs) control function 13 is designed to ensure the stability and the performance robustness of the laboratory scale water purification system.

In the second embodiment that is shown in FIG. 2, for controlling and regulating the permeate flow rate, a first flow meter 5 is also provided downstream of the permeate outlet for detecting the permeate flow rate produced by the reverse-osmosis device 2 and the process to control the permeate flow rate works similarly to that described above for the first embodiment.

However, the second embodiment differs from the first embodiment in the manner of controlling the RO recovery. A first (drain) conductivity cell 15 is provided to detect and monitor the RO drain conductivity that reflects the ion concentration in the recirculation loop. The first conductivity cell 15 is thus provided in the retentate stream either downstream of the membrane of the RO device 2 or downstream of the second flow rate regulator or drain valve 3 as indicated on the FIG. 2. A second conductivity cell 16 is provided in a section E of the feed medium flow path for detecting the conductivity (ion concentration) of the feed medium flow, which section E is further upstream of a point where the second retentate flow path B joins a feed line and thus upstream of a conductivity sensor 7 described later for measuring the conductivity of the mix of the feed stream with the stream from the second retentate flow path B.

Once the RO permeate flow is in a steady state, the concentration factor is used as the key parameter to prevent scaling on the feed side of the membrane of the RO device 2. A contaminants analysis of the feed water will allow computing the maximum concentration factor between the feed water and drain water (using the Langelier model described above). There is a mathematical relationship between the RO recovery (Lambda) and feed flow ion concentration and drain flow ion concentration. The concentration factor set point is met by simultaneously closing the recirculation valve 4 and opening the drain valve 3 (to decrease the concentration factor) or by simultaneously opening the recirculation valve 4 and closing the drain valve 3 (to increase the concentration factor). The RO permeate flow rate as well as concentration factor are then regulated in a closed loop manner such that a predetermined target recovery rate and a predetermined target permeate flow rate are controlled for the reverse-osmosis device 2. The FIG. 3 is a diagram showing the control input and output of the controller 13 of the first embodiment. In this figure the abbreviation “PF measured” refers to permeate flow rate as measured by the permeate flow rate sensor 5, “ROP” refers to RO pressure as measured by the pressure sensor 14, “SRF measured” refers to drain flow rate as measured by the drain flow sensor 6, “CMD1” refers to the control command output to the motorized needle valve 4, “CMD2” refers to the control command output to the motorized needle valve 3, “PF order” refers to the predetermined set target permeate flow rate, “R order” refers to the predetermined set target recovery rate.

The minimum control input of the controller 13 to implement the invention are thus the signal “PF measured” and the “SRF measured”. Although not shown the system may include a user interface including input means and means for directly outputting information on the system like a display, and/or a data interface for exchanging the relevant information between the system and another device adapted to display this information and communicate with the system. Useful output/display information is RO permeate flow rate, RO recovery (both determined by the system), RO pressure (minimum and maximum values) and RO pressure variation. The latter information requires the provision of a pressure sensor for detecting the RO pressure as described above and a corresponding input on the side of the controller.

The system may also include a function to stop the operation of the system in a situation where values exceeding certain predefined limits or threshold values for the RO pressure, the RO permeate flow rate and/or the RO recovery are detected.

Monitoring the Key Feed Water Contaminants without Resorting to Expensive Tools and Dedicated Sensors

Another aspect of the system and method of the invention in addition to reducing the water consumption by controlling the recovery rate and/or permeate flow rate as the main control targets is the capability to maintain the integrity of the membrane of the RO device and the integrity of the EDI device over a long time.

The control philosophy of the system in the context of fixed set or target points is as follows: upon installation on a specific geographic location, a tap water analysis is performed (feed conductivity, hardness, dissolved carbon dioxide concentration, temperature). Then, the RO recovery and deionization currents for the EDI device are computed so as to minimize the amount of water sent to the drain. The RO recovery and deionization currents are set on the system, i.e. are preferably input to the controller through a suitable user interface. From this point the RO recovery is automatically controlled over time to maintain the target value by controlling the preferably motorized needle valve actuators using the detection output from the flow meters 5, 6 on the permeate and drain streams.

Considering that the electro-deionization module 10 preferably comprises at least three stages in series as described in connection with the prior art, the controller 13 of the system of the invention is preferably also adapted to control the deionization current independently in each stage, the first stage being dedicated to the bulk of the ionic charge, the second stage being dedicated to the removal of carbon dioxide (CO2) and the third stage being dedicated to low ionized species, e.g. reactive silica and boron. Thus, the control scheme of the RO/EDI combination of the system of the invention will consist in controlling the RO recovery in order to adjust the permeate ionic load to the maximal admissible load of the EDI first stage. Therefore, the deionization of the first stage will be at its maximal so as to run the RO recovery at is maximal as well. The key parameter for this previous computation is the salt passage of the membrane of the RO device or the reverse of salt passage referred to as RO membrane rejection. The RO rejection changes over time depending mainly on the age of the membrane, the RO rejection is easily monitored using two conductivity sensors 7 and 8, i.e. a conductivity cell 7 in the feed medium flow path C for detecting the conductivity (ion concentration) of the feed medium stream of the RO device 2 and a second conductivity cell 8 in the permeate flow path D downstream of the RO device 2 for detecting the conductivity (ion concentration) of the permeate stream of the RO membrane. The rejection is the ratio between the permeate conductivity and the feed medium conductivity. Therefore, the RO recovery can be adjusted in real time according to the actual rejection of the RO membrane.

Thus, the controller 13 is preferably adapted to determine the actual rejection of the RO device 2 based on the ratio of the detection results from the conductivity cells 7 and 8, to adjust the target recovery rate of the RO stage depending on the determined actual rejection of the RO device 2 to a value at which the RO permeate ionic load and total hardness level are at or below their predetermined admissible value for the EDI device 10, preferably of the first stage thereof, and, if necessary, to adjust the deionization current of the EDI device 10, preferably of the first stage thereof, accordingly.

Having determined the optimal RO recovery to minimize the water consumption of the RO device, the other requirements must still be met in order to maintain the integrity of the components: the Langelier index should be below the specified limit of calcium carbonate precipitation and the Ca²⁺ and Mg²⁺ content in the RO permeate should be below the EDI specified limit. If the Langelier index is over the maximal specified limit, then the Langelier index will become the driver for the RO recovery set point. If the Ca²⁺ and Mg²⁺ content in the RO permeate still exceeds the maximal requirement of the EDI module, then the Ca²⁺ and Mg²⁺ content in the RO permeate will become the driver for the RO recovery set point. If either the Langelier index or the maximal Ca²⁺ and Mg²⁺ becomes the driver for the RO recovery, the ionic load of the permeate will not be the maximal one for the EDI module. Therefore the EDI current for the first stage of the EDI device needs to be recomputed and applied in real time.

The last parameters that need to be applied on the EDI device are the currents on stages 2 and 3. As seen before, the current on stage 2 depends on the dissolved carbon dioxide concentration of the feed water where dissolved carbon dioxide is not removed by the membrane of the RO device. Dissolved carbon dioxide concentration is first quantified by an analytic method upon system installation. However, it is desirable to monitor the dissolved carbon dioxide concentration over time. The method in the system of the invention is as follows: assuming the ionic load is fully removed by both the RO device and the first stage of the EDI module, if there was no current applied on stages 2 and 3 of the EDI module, the water conductivity after the EDI module could be attributed only to the carbon dioxide content (according to the CO₂ concentration/water conductivity curve applicable with deionized water).

Therefore, a periodic sequence dedicated to CO₂ measurement is operated in order to update the EDI current on stage 2. The current of the last stage of the EDI module is adjusted in a closed loop manner according to the resistivity of the purified water produced by the EDI module. Thus, a fifth conductivity cell 9 is preferably provided downstream of the purified water outlet of the EDI device 10 for detecting the conductivity (ion concentration) of the purified water, and the controller 13 is adapted to determine the CO₂ content of the purified water based on the detection results from the fifth conductivity cell 9, and to adjust the deionization current of the electro-deionization device 10, preferably of the second and, if provided, of the third stage thereof accordingly.

Assuming that the EDI device in the system is properly operated according to the above mentioned control scheme, the impedance of each stage will increase slowly over time. The impedance increase rate provides an indication of the Ca²⁺ and Mg²⁺ content in the feed water over time. The controller 13 may thus include a further function to detect and monitor the impedance increase rate of the stages of the EDI device and to modify the target RO recovery in accordance with a detected or monitored change of the Ca²⁺ and Mg²⁺ content in the feed water.

The advantages of the system and method of the invention are partly described above and are partly summarized below. The system requires less components to control the RO recovery. Solenoid valves can be replaced by motorized valves. The water consumption is reduced while maintaining the quality of the purified water produced at the outlet of the EDI device. The integrity of the RO device and of the EDI device are maintained for a long period of time while an increased feed water temperature range can be accepted.

As specifically compared to the water purification system described in EP 1457460 A2 which uses an eyelet device to provide a constant flow rate by means of a deformable orifice so that the flow rate control device adds an extra pressure drop in the RO permeate stream because the eyelet device requires a minimal pressure of 1 bar to work properly (resulting in a maximal transmembrane pressure of 14 bar since the pump has a maximal bypass pressure of 15 bar), a trans-membrane pressure of 15 bars is available with the flow schematic of the present invention. The present invention thus provides a system that extends the operating temperature range by 10% while keeping a constant flow rate.

The capability of the system and method of the invention to react to a change of feed water temperature is particularly advantageous in view of the fact that the following operating conditions push the RO/EDI combination to the extreme of its operating range whereas the flow schematic of the present invention provides a solution to automatically enable the system to keep on producing pure water.

Feed water temperature is too high: this is a well-known failure mode of the RO membrane. As the water temperature increases, the RO membrane permeability increases requiring the RO pressure to decrease as well to keep the flow rate constant. As known in the art, RO rejection decreases simultaneously making the RO permeate ionic load to increase. Since the EDI module cannot cope with a higher feed water ionic load, the system is expected to decrease the RO recovery to keep the ionic load constant.

Feed water temperature is too low: in that case the permeability of the RO membrane decreases to the point where the pump can no longer accommodate the RO pressure to keep a constant RO permeate flow rate.

At some point, the system will no longer provide the expected RO permeate flow rate, therefore decreasing the ionic load seen by the EDI module. The system will keep on producing water and the deionization currents of stage 1 and 2 will decrease accordingly.

In addition to the basic automatic control scheme provided by the both embodiments and the resulting advantages described above, the present invention provides additional functions to monitor essential purification components of the system and to use the information available in the system including the RO/EDI combination to provide information to the outside that certain maintenance work is required in order to maintain or restore the performance of the system.

A typical failure mode of the membrane of the RO device 2 is a loss of permeability and a loss of rejection. The RO membrane permeability is characterized as the RO permeate flow rate for a specific water temperature. As the RO membrane ages, some fouling may occur and the permeability of the RO membrane decreases. To compensate the decrease in permeability the system will normally automatically increase the RO pressure. In that a pressure sensor 14 is optionally provided for detecting the pressure of the retentate flow in the first retentate flow path A and/or the second retentate flow path B, the controller 13 can include a function allowing it to determine a difference between a predetermined or theorical retentate pressure value and the actual pressure value detected by the pressure sensor 14. When the detected difference exceeds a specified threshold, the controller may trigger or issue an indication/alarm meaning that the membrane in the RO device 2 is to be cleaned or replaced.

Another typical failure mode of the membrane of the RO device is the drop in rejection. The controller may include a function to memorize the loss of rejection overtime with the aging of the system components and at some time to trigger an alarm or indication.

Using the detection result of the pressure sensor 14 the system can also include a function of monitoring the wear of the pump over time. To this end a typical failure mode of the positive displacement pump 1 is the loss of flow-rate when the RO pressure increases. The controller 13 may include a function to perform a pump testing routine including the steps of closing the second flow rate regulator 4, increasing the RO retentate pressure to a specific value by closing the first flow rate regulator 3, monitoring the detected retentate pressure from the pressure sensor 14, and comparing the flow rate of the retentate flow detected by the second flow meter 6 with a predetermined set flow rate threshold value (theoretical minimal value) predetermined for a specific retentate pressure value corresponding to that detected by the pressure sensor 14, and issueing an indication/warning if the flow rate detected by the second flow meter 6 is lower than said threshold value so that a preventive maintenance of the pump.

A typical failure mode of the EDI device on the other hand is the impedance increase over time as some scaling occurs in the systems. The controller 13 may include, in the context of its capabilities to control the power supply of the stages of the EDI device, a further function of monitoring the impedance of the system over time and to trigger an alarm or indication when the impedance of the module reaches as specified set point.

Although not explicitly shown in the figures the RO device may be formed from one or a plurality of cartridges that are arranged in series or parallel. Additional sensor may be provided for detecting additional parameters of the flow at the respective positions in the system. These additional sensors may include temperature sensors, for example. The pretreatment of the tap water upstream of the pump 1 is described in the background section as being potentially required to condition the tap water suitable for treatment in the RO device. Accordingly, the system can include such a pretreatment device if desired. Although the controller 13 is shown schematic as a block, it can be implement in a single component or in the form of a circuit or in the form of a universal computer on which a software program is loaded that renders the universal computer suitable to carry out the control processes. Further, the term “controller” should encompass any additional circuitry required to effect the control.

1. A method of purifying tap water to produce deionized type 2 pure water on a laboratory scale with a volume of up to 300 l/h using a water purification system which comprises:
a feed medium flow path (C) including a pump (1) for elevating the pressure of the feed medium and supplying the feed medium under pressure to a feed inlet of a reverse-osmosis device (2), wherein the reverse-osmosis device (2) is adapted to produce a permeate flow and a concentrate flow from the feed medium and has a permeate outlet and a retentate outlet;
an electro-deionization device (10) having an inlet in fluid communication with the permeate outlet of the reverse-osmosis device (2), and a purified water outlet;
a first retentate flow path (A) in fluid communication with the retentate outlet of the reverse-osmosis device (2), for removing retentate from the system, said first retentate flow path (A) including a first flow rate regulator (3) adapted to be remote controlled; and
a second retentate flow path (B) in fluid communication with the retentate outlet of the reverse-osmosis device (2) for recirculating retentate to the feed medium flow path at an upstream position of the pump (1), said second retentate flow path (B) including a second flow rate regulator (4) adapted to be remote controlled;
wherein said method comprises:
detecting the permeate flow rate produced by the reverse-osmosis device (2) downstream of the permeate outlet;
detecting the flow rate of the retentate flow that is removed from the system downstream of the first flow rate regulator (3); and
remote controlling the first and second flow rate regulators (3,4) based on the detection results from the first and second flow meters (5,6) such that a predetermined target recovery rate and a predetermined target permeate flow rate are controlled for the reverse-osmosis device (2).

2. A method of purifying tap water to produce deionized type 2 pure water on a laboratory scale with a volume of up to 300 l/h using a water purification system which comprises:
a feed medium flow path (C,E) including a pump (1) for elevating the pressure of the feed medium and supplying the feed medium under pressure to a feed inlet of a reverse-osmosis device (2), wherein the reverse-osmosis device (2) is adapted to produce a permeate flow and a concentrate flow from the feed medium and has a permeate outlet and a retentate outlet;
an electro-deionization device (10) having an inlet in fluid communication with the permeate outlet of the reverse-osmosis device (2), and a purified water outlet;
a first retentate flow path (A) in fluid communication with the retentate outlet of the reverse-osmosis device (2), for removing retentate from the system, said first retentate flow path (A) including a first flow rate regulator (3) adapted to be remote controlled; and
a second retentate flow path (B) in fluid communication with the retentate outlet of the reverse-osmosis device (2) for recirculating retentate to the feed medium flow path at an upstream position of the pump (1), said second retentate flow path (B) including a second flow rate regulator (4) adapted to be remote controlled;
wherein said method comprises:
detecting the permeate flow rate produced by the reverse-osmosis device (2) downstream of the permeate outlet;
detecting the conductivity (ion concentration) of the retentate flow;
detecting the conductivity (ion concentration) of the feed medium flow; and
controlling the first and second flow rate regulators (3,4) based on the permeate flow rate produced by the reverse-osmosis device (2) and the conductivity (ion concentration) of the retentate flow and the conductivity (ion concentration) of the feed medium flow such that a predetermined target recovery rate and a predetermined target permeate flow rate are controlled for the reverse-osmosis device (2).
